(19) United States
(12) Patent Application Publication
(10) Pub. No.: US 2005/0088691 A1
(43) Pub. Date: Apr. 28, 2005

(54) Apparatus and method of optimizing printout speed of image forming apparatus

(76) Inventor: Chang-sub Lee, Seoul (KR)

Correspondence Address: STANZIONE & KIM, LLP, 1740 N STREET, N.W., FIRST FLOOR, WASHINGTON, DC, 20036, US

(21) Appl. No.: 11/000,068

(22) Filed: Dec. 1, 2004

(30) Foreign Application Priority Data
May 12, 2003 (JP) 2003-87987

(51) Int. Cl. G06F 3/12; G06F 13/00

(52) U.S. Cl. 358/1.15; 719/321

(57) ABSTRACT

An apparatus and method of optimizing printout speed of an image forming apparatus which allows users to set a printout speed when users are going to print a document having a plurality of pages, such that overall printout time of the document can be reduced. The apparatus to optimize a printout speed of the image forming apparatus includes a printout speed setup unit which sets a printout speed value for the image forming apparatus, and a printout speed applying unit which makes a printer engine of the image forming apparatus maintain an on-state during a time period corresponding to the printout speed value.

### CROSS-REFERENCE TO RELATED APPLICATIONS

This application claims the priority of Korean Patent Application No. 2003-87987, filed on Dec. 5, 2003, in the Korean Intellectual Property Office, the disclosure of which is incorporated herein in its entirety by reference.

### BACKGROUND OF THE INVENTION

1. Field of the Invention

The present general inventive concept relates to an apparatus and method of optimizing printout speed of an image forming apparatus, and more particularly, to an apparatus and method of optimizing printout speed of an image forming apparatus that allows users to set printout speed when users want to print a document having a plurality of pages such that overall printout time of the document can be reduced.

2. Description of the Related Art

Generally, a facsimile, a printer, a copier, and a multi-function printer (MFP) that combines the functions of a printer, scanner, copier or facsimile essentially have an image forming apparatus for a print job. A typical image forming apparatus adopts an electrophotographic developing method of which processes include sequential steps of charging, exposing, developing, transferring and fixing.

Since personal computer users recently deal with documents having a lot of multimedia data, a lot of graphics and Internet pages are included in the documents, and thus the documents are complicated and diversified, such that the image forming apparatus is required to have an improved printout speed to print the documents quickly.

An image forming apparatus designed to improve printout speed is disclosed in U.S. Pat. No. 5,878,197.

A structure and print processes of a typical image forming apparatus will now be described with reference to FIG. 1.

Referring to FIG. 1, an image forming apparatus 50 includes a controller 52, a memory 54, a printer engine 55, an operating panel equipment (OPE) 56, and an external system interface 57. A computer 10 includes an application program 3, a printer driver 5 and an input-output interface 7.

The controller 52 controls an overall operation of the image forming apparatus according to a control program stored in the memory 54. The memory 54 stores program data, protocol data, font data, and so on. The data of the memory 54 are accessed or stored by the controller 52. The OPE 56 includes a display and a plurality of keys capable of generating key data for the controller 52. The display, such as an LCD, displays output results according to an operation of the controller 52. The external system interface 57 that is controlled by the controller 52 receives print data from an external system such as the computer 10. The printer engine 55 prints the print data received from the external system according to a control of the controller 52.

If a computer user orders a printout after editing a document with the application program 3, such as a word processor, the printer driver 5 of the computer 10 converts the document into data that the image forming apparatus 50, i.e., a printer can understand. The transformed data are transmitted from the input-output interface 7 of the computer 10 to the external system interface 57 of the image forming apparatus 50, the input-output interface having a serial or a parallel port. The controller 52 analyses the transmitted data in order to generate image data per each page of the transmitted data for the printer engine 55.

Every time the controller 52 has finished generating of the image data corresponding to one page of the transmitted data, the controller 52 sends a print order signal to the printer engine 55. If the printer engine 55 is ready to print when it receives the print order signal, it sends a vertical synchronous signal (VSYNC) to the controller 52 as a response. The printer engine 55 also sends a horizontal synchronous signal (HSYNC) to the controller 52 after sending the VSYNC in order for a horizontal synchronization.

FIG. 2 is a timing chart showing control-related signals between the controller 52 and the printer engine 55.

Referring to FIG. 2, D indicates a time difference between the print order signal and the VSYNC, TC1 indicates a time interval between a first print order signal A and a second print order signal B, and TC2 indicates a time interval between the second print order signal B and a third print order signal C. That is, each of the TC1 and TC2 indicates a time difference between the print order signals and it is proportional to a time taken to generate the image data at the controller 52. If the data transmitted from the computer 10 are complicated, the image data of the controller 52 increases in quantity such that the time intervals between the print order signals become long.

The controller 52 sends the image data to the printer engine 55 according to the HSYNC received from the printer engine 55. The printer engine 55 prints the image data received from the controller 52.

After printing the image data, the printer engine 55 waits for a next print order signal from the controller 52 during a predetermined time period Tᵢₙ according to a printout speed specification thereof.

If the next print order signal is not sent from the controller 52 within the predetermined time period Tᵢₙ, the printer engine 55 understands that there is no subsequent print order signal, such that the printer engine 55 changes its state from on to Ready and turns its drive motor off.

If the controller 52 does not send the next print order signal, such as print signal C, to the printer engine 55 in Tᵢₙ, the printer engine 55 turns the drive motor OFF in order to change its state from ON to Ready. Thereafter, the printout may be carried out when the printer engine 55 enters the on-state again after the operation of the drive motor.

According to the related art as described above, the controller 52 generates the image data and the printer engine 55 print the image data. If there are two of more pages to be printed, the controller 52 generates the image data per each page within the predetermined time period Tᵢₙ. For example, 20 PPM (page per minute) image forming apparatus prints one page per 3 seconds. Each time the controller 52 generates the image data it sends the image data to the printer engine 55 for printout.

By the way, if the controller 52 does not send the print order signal to the printer engine 55 within the predetermined time period Tᵢₙ (3 seconds in above example) because it takes a large amount of time to generate the next image data after sending the print order signal corresponding to a preceding image data, the printer engine 55 judges that there are no more subsequent image data to be printed and turns the printer engine drive motor off, causing a document having two or more pages to be printed discontinuously. As a result, the document having two or more pages is printed with the appearance and time span more like several separate documents.

Therefore, if the controller 52 does not generate the image data within the predetermined time period Tᵢₙ of the image forming apparatus specification when a document having two or more pages is printed, the printer engine 55 judges that there are no more subsequent image data to be printed, and then turns the printer engine drive motor off in order to change its state from on to Ready. If the controller 52 has generated the next image data and sends the print order signal when the printer engine 55 is the READY state, the printer engine 55 turns the print engine drive motor on again to change the Ready state to the on-state so that useless off-to-on time of the drive motor is generated, thereby increasing the overall printout time.

In other words, the image forming apparatus of the related art has the drawback in that Tₙₒ shown in FIG. 2 can be accumulated such that the overall printout time increases when the document has two or more pages.

Herein, the Tₙₒ indicates a sum of two time periods, a time period in which the drive motor is off and a time required for changing the printer engine 55 from the READY state to the on-state after receiving the print order signal.

### SUMMARY OF THE INVENTION

The present general inventive concept provides an apparatus and method of optimizing printout speed of an image forming apparatus that allows users to set printout speed when users are going to print a document having a plurality of pages such that overall printout time of the document can be reduced.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an apparatus to optimize printout speed of an image forming apparatus, including a printout speed setup unit which sets a printout speed value for the image forming apparatus, and a printout speed applying unit which makes a printer engine of the image forming apparatus maintain an on-state during a time period corresponding to the printout speed value.

The printout speed setup unit may be provided in an OPE (operating panel equipment) of the image forming apparatus or a printer driver of a terminal which sends document data to the image forming apparatus.

The printout speed value may be stored in a memory such as a flash memory or an EEPROM of the image forming apparatus.

The foregoing and/or other aspects and advantages of the present general inventive concept may be also achieved by providing a method of optimizing printout speed of an image forming apparatus, including setting a printout speed value for the image forming apparatus, and applying the printout speed value to a printer engine of the image forming apparatus to maintain an on-state of the printer engine during a time period corresponding to the printout speed value.

The printout speed value may be set in order for a time period corresponding thereto to be longer than any of time intervals between vertical synchronous signals (VSYNCs) generated at the printer engine in order to respond to image data to be printed.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic block diagram illustrating a printout speed of an image forming apparatus according to the related art;

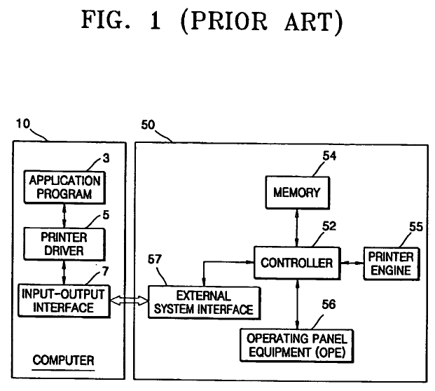

FIG. 2 is a timing chart illustrating a printout speed of an image forming apparatus according to the related art;

FIG. 3 is a schematic block diagram illustrating an image forming apparatus of which printout speed is optimized, according to an embodiment of the present general inventive concept;

FIG. 4 is a schematic block diagram illustrating an image forming apparatus of which printout speed is optimized, according to another embodiment of the present general inventive concept;

FIG. 5 is a flow chart illustrating a method of optimizing printout speed of an image forming apparatus, according to another embodiment of the present general inventive concept;

FIG. 6 is a flow chart illustrating an apparatus and method of optimizing printout speed of an image forming apparatus according to the embodiments of the present general inventive concept; and

FIG. 7 is a timing chart illustrating timing of optimizing printout speed of an image forming apparatus according to the embodiments of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

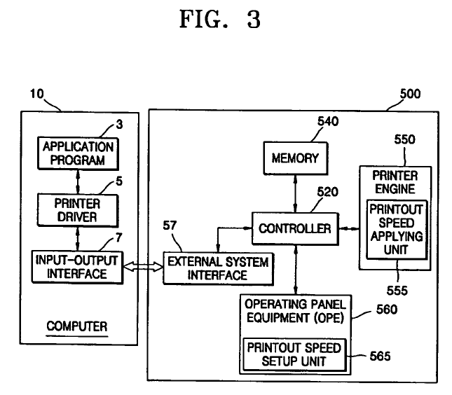

Referring to FIG. 3, an image forming apparatus 500 includes a printout speed setup unit 565 in an operating panel equipment (OPE) 560 to set a printout speed value. The printout speed setup unit 565 includes predetermined keys provided in the OPE 560. A printout speed setup value that can be adjusted by manipulating the keys is stored in a memory 540 through a controller 520, and this value may be displayed on a display (not shown) of the OPE 560. The memory 540 may include a flash memory or an EEPROM.

A printout speed applying unit 555 is embedded in a printer engine 550 for the printer engine 550 to maintain an on-state during a time period corresponding to the printout speed setup value. A few examples are as follows: if the speed setup value is 15 PPM, the printer engine 550 maintains the on-state for 4 seconds; or if the speed setup value is 10 PPM, the printer engine 550 maintains the on-state for 6 seconds; and the like. That is, during an interval between a first print order signal and a second print order signal, the printer engine 550 maintains the on-state for the time period (4 or 6 sec in examples).

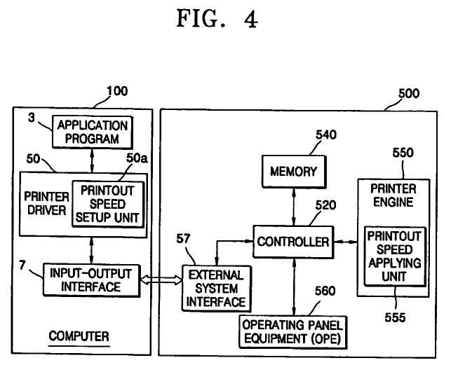

Though the printout speed setup unit 565 is embedded in the OPE 560 of the image forming apparatus 500 according to the embodiment illustrated in FIG. 3, it may be included in a printer driver 50 that is installed in a computer 100 according to another embodiment shown in FIG. 4.

In case a printout speed setup unit 50a is included in the printer driver 50, a printout speed setup value of the image forming apparatus 500 is adjusted through the printer driver 50. The printout speed setup unit 50a is a form of computer program and an input device such as a keyboard or a mouse may be used to input the printout speed setup value.

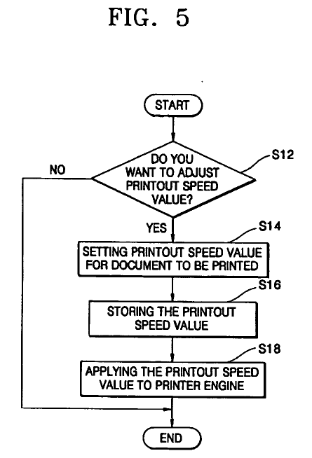

Referring to FIG. 5, there is a method that is embodied in the apparatus of FIGS. 3 and 4 to optimize printout speed of an image forming apparatus.

In operations S12 and S14, a wanted printout speed setup value is inputted. In operation S16, the printout speed setup value and/or a corresponding time period (e.g., if the printout speed setup value is 10 PPM, the corresponding time period is 6 seconds) is stored in the memory 540 of the image forming apparatus 500. In operation S18, the printer engine 550 generates a vertical synchronous signal (VSYNC) for a page to be printed and keeps the drive motor thereof in an on-state during the corresponding time period.

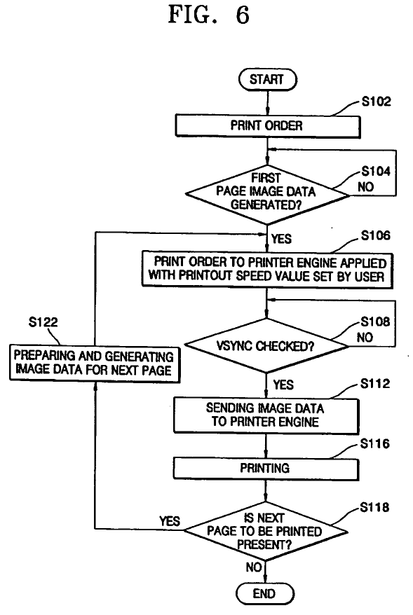

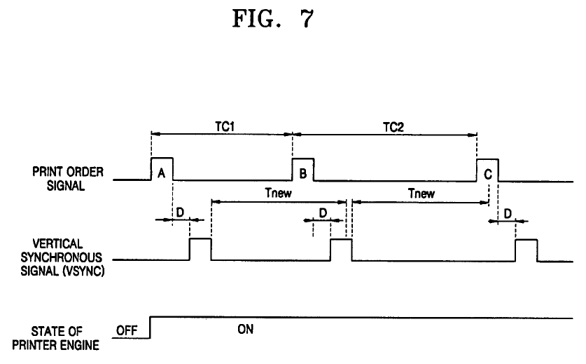

Operations of the apparatus and method of optimizing printout speed of the image forming apparatus having the above construction will now be described with reference to FIGS. 6 and 7.

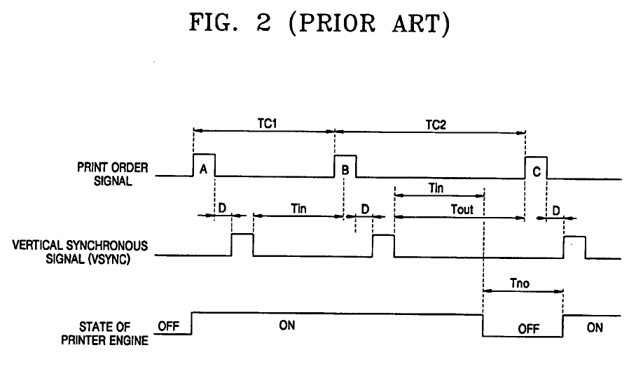

For example, if useless off-to-on time is generated at a drive motor of the printer engine 550 when a document with a plurality of pages is printed, as mentioned in the description of the related art, the printout speed setup value is reset through the printout speed setup unit 565 of the OPE 560 (see FIG. 3) or through the printout speed setup unit 50a of the printer driver 50 (see FIG. 4) in order for the printer engine 550 to be in the on-state for a period somewhat longer than Tₒᵤₜ (see FIG. 2). That is, the printout speed setup value is adjusted from Tᵢₙ (see FIG. 2) to T_{new} (see FIG. 7) such that a time period TC2 between a second print order signal B and a third print order signal C can end within the T_{new} time frame, thereby allowing the printer engine 550 to be in the on-state until all the pages of the document are printed. Therefore, the apparatus and method of the present general inventive concept reduces an overall printout time by preventing a Tₙₒ time from existing, which is the time at which the printer engine is in the off state (see FIG. 2).

For reference, 20 PPM and 10 PPM printout speeds correspond to 3 sec and 6 sec time periods, respectively. The time period is a maximal time during which the printer engine 550 can generate a next VSYNC after generating a previous VSYNC without turning its state off. If the next VSYNC is not generated during the time period, the printer engine turns its state off. Therefore, it can be understood that the time period is not an actual printout time.

Referring to FIG. 6, in operation S102 a computer user orders printout after editing a document with an application program 3 (see FIGS. 3 and 4). A printer driver 5 or 50 of the computer 10 or 100 converts the document into data that the image forming apparatus 500, i.e., a printer, can understand. The converted data are transmitted from an input-output interface 7 of the computer 10 or 100 to an external system interface 57 of the image forming apparatus 500, the input-output interface having a serial or a parallel port. In operation S104, the controller 520 analyses the transmitted data in order to generate image data per each page of the transmitted data for the printer engine 550.

In operation S106, the controller 520 finishes generating the image data corresponding to one page of the transmitted data and sends a print order signal to the printer engine 550. Herein, the printout speed of the printer engine 550 has been set and the printout speed setup value has been applied to the printer engine 550 by the printout speed applying unit 555 before the operation S106, as shown in FIG. 7.

In operation S108, if the printer engine 550 is ready to print when it receives the print order signal, it sends a VSYNC to the controller 520 as a response. The printer engine 550 also sends a horizontal synchronous signal (HSYNC) to the controller 520 after sending the VSYNC in order for a horizontal synchronization, which is similar to that described in the related art.

In operation S112, the controller 520 sends the image data to the printer engine 550 according to the HSYNC received from the printer engine 550. In operation S116, the engine 550 prints the image data received from the controller 550. In operation S118, the engine 550 waits for a next print order signal from the controller 520 after sending the VSYNC to the controller 520 during a predetermined time T_{new} corresponding to the printout speed setup value, as shown in FIG. 7.

If there is a next page to be printed, the controller 520 generates image data for the next page and repeats operations S106 through S122 until all pages of the document are printed.

The apparatus and method of the embodiments of the present general inventive concept maintain the printer engine 550 in the on-state until the document having a plurality pages is completely printed, as shown in FIG. 7, thereby reducing the overall printout time of the document.

As described above, the apparatus and method of optimizing printout speed of the image forming apparatus according to the embodiments of present general inventive concept allow users to set the printout speed when users are going to print the document having a plurality of pages, such that the overall printout time of the document can be reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An apparatus to optimize printout speed of an image forming apparatus, comprising:
a printout speed setup unit which sets a printout speed value for the image forming apparatus; and
a printout speed applying unit which makes a printer engine of the image forming apparatus maintain an on-state during a time period corresponding to the printout speed value.

2. The apparatus of claim 1, wherein the printout speed setup unit is provided in an OPE (operating panel equipment) of the image forming apparatus.

3. The apparatus of claim 2, wherein the printout speed setup unit includes a predetermined set of input keys.

4. The apparatus of claim 1, wherein the printout speed setup unit is provided in a printer driver of a terminal that sends document data to the image forming apparatus.

5. The apparatus of claim 4, wherein the printout speed setup unit is formed of a computer program and an input device.

6. The apparatus of claim 1, wherein the printout speed value is stored in a memory of the image forming apparatus.

7. The apparatus of claim 6, wherein the memory is either a flash memory or an EPROM.

8. The apparatus of claim 1, wherein the printout speed applying unit is embedded within the printer engine.

9. An image forming apparatus comprising:
a printer engine to print image data to a recording medium;
a controller to send a print order signal and image data to be printed to the print engine; and
a printout speed setup unit to set/reset a printout speed setup value for the printer engine when a document of at least two pages are to be printed, the printout speed setup value being associated with a rate at which the print engine sends a VSYNC signal to the controller notifying the controller that the print engine is ready to print more data of the document.

10. The image forming apparatus of claim 9, wherein the printer engine comprises a printout speed applying unit to receive the printout speed setup value and apply the printout speed setup value to the printer engine to maintain an on-state during a time period corresponding to the printout speed setup value.

11. The image forming apparatus of claim 9, further comprising an external system interface to interface with an external terminal to receive printer driver information.

12. A method of optimizing printout speed of an image forming apparatus, comprising:
setting a printout speed value for the image forming apparatus; and
applying the printout speed value to a printer engine of the image forming apparatus to maintain an on-state of the printer engine during a time period corresponding to the printout speed value.

13. The method of claim 12, wherein the setting of a printout speed is carried out by an OPE of the image forming apparatus.

14. The method of claim 12, wherein the setting of a printout speed is carried out by a printer driver of a terminal which sends document data to the image forming apparatus.

15. The method of claim 12, wherein the printout speed value is stored in a memory of the image forming apparatus.

16. The method of claim 12, further comprising:
storing the printout speed value and/or a time period corresponding thereto in a memory of the image forming apparatus.

17. The method of claim 12, wherein the printout speed value is set in order for a time period corresponding thereto to be longer than any of time intervals between vertical synchronous signals (VSYNCs) generated at the printer engine in order to respond to image data to be printed.

18. A method of optimizing printout speed of an image forming apparatus, comprising:
inputting a predetermined printout speed setup value to the image forming apparatus when a document with a plurality of pages is to be printed; and
applying the predetermined printout speed setup value to a printer engine to adjust the time frame at which the printer engine sends a signal to a controller to forward image data of the document to be printed.

19. The method of claim 18, wherein the signal sent to the controller from the print engine is a VSYNC signal.

20. The method of claim 18, wherein the setting of a printout speed is carried out by an OPE of the image forming apparatus.

21. The method of claim 18, wherein the setting of a printout speed is carried out by a printer driver of a terminal which sends document data to the image forming apparatus.

22. The method of claim 18, wherein the printout speed value is stored in a memory of the image forming apparatus.
